(19) United States
(12) Patent Application Publication
(10) Pub. No.: US 2002/0040722 A1
(43) Pub. Date: Apr. 11, 2002

(54) Surface treatment method for GaAs substrate

(76) Inventor: Takehiko Okajima, Tokyo (JP)

Correspondence Address: VENABLE, BAETJER, HOWARD AND CIVILETTI, LLP, P.O. BOX 34385, WASHINGTON, DC, 20043-9998, US

(21) Appl. No.: 09/932,019

(22) Filed: Aug. 20, 2001

(30) Foreign Application Priority Data
Aug. 30, 2000 (JP) 2000-261193

(51) Int. Cl. B08B 7/04

(52) U.S. Cl. 134/1.3; 134/2; 134/26; 134/30

(57) ABSTRACT

A surface treatment method for a GaAs substrate in which an oxide film on a surface of the GaAs substrate can be nitrided efficiently to form GaN. The surface treatment method includes a first process of forcedly oxidizing the surface of the GaAs substrate and a second process which, subsequently to the first process, washes the surface of the GaAs substrate with running water. The forced oxidation may be carried out by immersing the GaAs substrate in aqueous hydrogen peroxide solution or by treating the GaAs substrate by oxygen (O₂) ashing.

### BACKGROUND OF THE INVENTION

1. Field of the Invention

The present invention relates to a surface treatment method for a GaAs substrate to form a GaN insulating layer on a surface of the GaAs substrate.

2. Description of the Related Art

If an insulating layer cannot be formed on a surface of a GaAs substrate, a MOS cannot be fabricated. However, if GaN is formed on the surface of the GaAs substrate, a MOS can be fabricated. When GaN is formed on the surface of the GaAs substrate, there may be cases in which organic matter has adhered to the surface of the GaAs substrate during fabrication process or during storage. Thus, a process which forms GaN on the surface of the GaAs substrate after removing the organic matter by washing has been carried out.

As a method for washing and removing the organic matter on the surface of the GaAs substrate, a method which removes the organic matter by dissolving or decomposing the GaAs substrate with a solvent or a mixed solution of phosphoric acid and aqueous hydrogen peroxide solution has been employed. After the above-described process, a process which nitrides an oxide film on the surface of the GaAs substrate, using nitrogen plasma or the like, to form GaN has been carried out.

However, in conventional methods, it takes a long time to nitride the oxide film on the surface of the GaAs substrate to form the GaN. Thus, conventional methods are not efficient. Further, the obtained oxide film is not substantially formed only of GaN, and has some problems in its characteristics.

### SUMMARY OF THE INVENTION

An object of the present invention is to provide a surface treatment method for a GaAs substrate in which an oxide film on a surface of the GaAs substrate can be efficiently nitrided to form GaN, and a film can be obtained that is formed substantially only of GaN.

The above object is accomplished by the following surface treatment method for a GaAs substrate.

Namely, in accordance with a first aspect, the surface treatment method for a GaAs substrate of the present invention includes a first process which forcedly oxidizes a surface of the GaAs substrate, and a second process which, subsequently to the first process, washes the surface of the GaAs substrate with running water.

Examples of the GaAs substrate include a GaAs substrate, an AlGaAs substrate, an AlGaN substrate and the like.

The forced oxidation includes contact of the GaAs substrate with an oxidizing liquid or an oxidizing gas.

In accordance with another aspect of the present invention, in the surface treatment method for a GaAs substrate, the oxidizing liquid is aqueous hydrogen peroxide solution and the GaAs substrate is immersed in the aqueous hydrogen peroxide solution.

In accordance with still another aspect of the present invention, in the surface treatment method for a GaAs substrate of the present invention, the oxidizing gas is oxygen (O₂) and the GaAs substrate is treated by oxygen (O₂) ashing.

In accordance with a further aspect of the present invention, a method for forming a GaN insulating layer on a surface of a GaAs substrate includes a first process which forcedly oxidizes the surface of the GaAs substrate, a second process which washes the surface of the GaAs substrate with running water, and a third process which exposes the GaAs substrate to nitrogen plasma.

In accordance with the present invention, a GaAs substrate is actively oxidized to form an oxide film having a desired thickness. The oxide film is formed of Ga₂O₃ having an amorphous structure and arsenic oxides. The Ga₂O₃ having an amorphous structure is difficult to dissolve in water, but the As oxides have a characteristic of being easily dissolved in water. The As oxides are dissolved and removed from the oxide film as much as possible by the washing-with-running water, while the Ga₂O₃ having an amorphous structure remains. Thus, As oxides, which act to suppress a nitriding reaction, are removed from the oxide film. As a result, the GaAs substrate is substantially the Ga₂O₃ having an amorphous structure. By nitriding the Ga₂O₃ having an amorphous structure, an insulating film formed of GaN is formed.

### BRIEF DESCRIPTION OF THE DRAWINGS

FIGS. 1A to 1E are process views illustrating one preferred embodiment of a surface treatment method for a GaAs substrate of the present invention, showing an example of a forced oxidation treatment carried out using aqueous hydrogen peroxide solution.

FIGS. 2A to 2C are explanatory views illustrating typical structure of an oxide film in the surface treatment method for a GaAs substrate of the present invention.

FIGS. 3A to 3E are process views illustrating another preferred embodiment of the surface treatment method for a GaAs substrate of the present invention, showing an example of forced oxidation which is carried out using oxygen (O₂) ashing.

### DESCRIPTION OF THE PREFERRED EMBODIMENTS

Hereinafter, a description will be given of preferred embodiments of the present invention.

Substrate

In the present invention, “GaAs substrate” refers to a substrate formed of a material including at least the elements Ga and As and having semiconductor characteristics, such as a GaAs substrate, an AlGaAs substrate, an InGaAs substrate or the like.

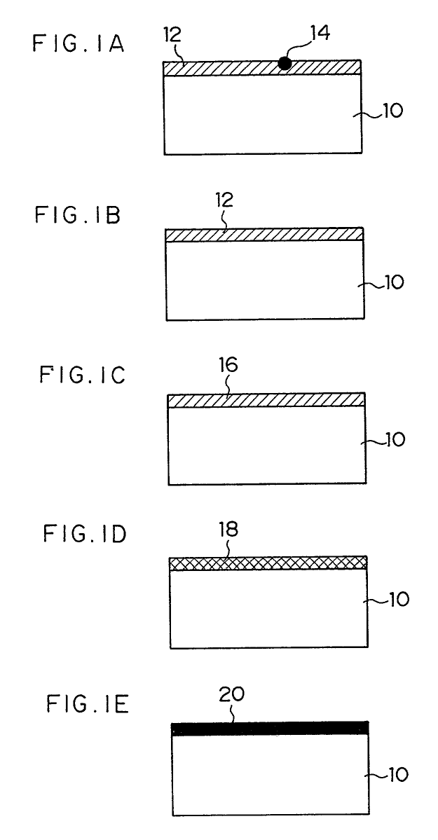

Of these substrates, treatment of the GaAs substrate will be described, with reference to FIG. 1.

As shown in FIG. 1A, a natural oxide film 12, which is formed by oxygen in air, is formed on a surface of a GaAs substrate 10. The natural oxide film 12 is formed of Ga₂O₃ and arsenic oxides. Organic matter 14 adheres to a surface of the natural oxide film during manufacturing, storage and the like of the GaAs substrate

Organic Matter Washing Treatment

In the present invention, as shown in FIG. 1B, in order to remove the organic matter 14, a solvent which is able to dissolve the organic matter, such as acetone, methyl ethyl ketone, methyl cellosolve, remover or the like, is used to dissolve the organic matter. At this time, an ultrasonic wave is preferably applied to the GaAs substrate from the underside thereof, such that dissolved or swelled organic matter is easily removed from the substrate. Also, the GaAs substrate is washed to remove the solvent and the organic matter therefrom, and discharge the same outside the process. Then, the GaAs substrate 10 is dried by nitrogen blowing.

Forced Oxidation

Next, as shown in FIG. 1C, the GaAs substrate 10 is forcedly oxidized. An oxidizing liquid or an oxidizing gas can be used for the forced oxidation. Examples of the oxidizing liquid include aqueous hydrogen peroxide solution, potassium permanganate, perchloric acid and the like. Oxygen can be used as the oxidizing gas. Among these, aqueous hydrogen peroxide solution is especially preferable from an industrial standpoint.

If, as described above, aqueous hydrogen peroxide solution is used (30%) as the oxidizing liquid, a time for which the GaAs substrate 10 is immersed in the aqueous hydrogen peroxide solution (30%) is 30 seconds to 3 minutes, preferably of the order of 10 sec. to 5 min., and more preferably of the order of 30 sec. to 60 sec. If the time the GaAs substrate 10 is immersed in the aqueous hydrogen peroxide solution (30%) is shorter than 30 seconds, it will be difficult to form an oxide film having a thickness necessary for forming a GaN insulating film. On the other hand, if the time is longer than three minutes, excessive oxide will be formed, and an oxide film thicker than the thickness needed for forming the GaN insulating film will be formed.

In a case of using oxygen (O₂) as the oxidizing gas, a duration of oxygen (O₂) ashing is preferably from 30 seconds to 15 minutes and more preferably around 5 minutes. If the oxygen (O₂) ashing time is shorter than 30 seconds, it will be difficult to form an oxide film having a thickness necessary for forming the GaN insulating film. On the other hand, if the oxygen (O₂) ashing time is longer than 15 minutes, excessive oxide will be formed, and an oxide film thicker than the thickness needed for forming the GaN insulating film will be formed.

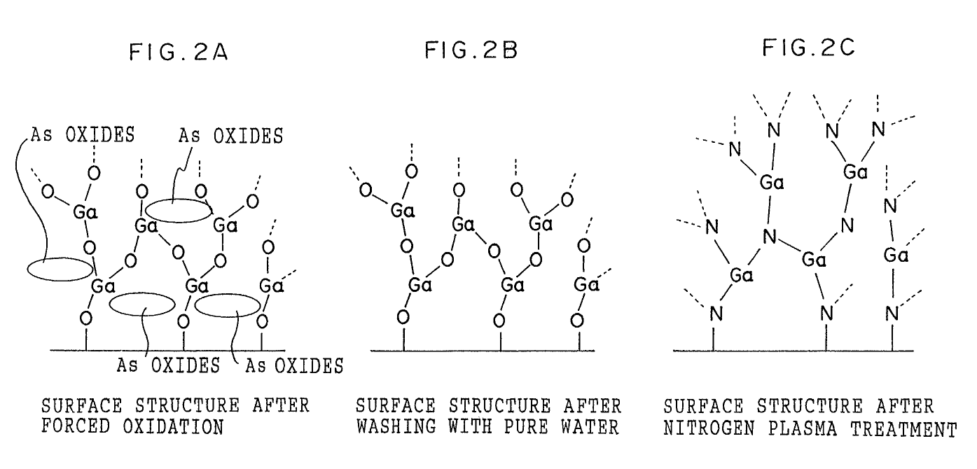

By such a forced oxidation treatment, the oxide film 12 is formed into an oxide film 16 composed of Ga₂O₃ having an amorphous structure and As oxides, as shown typically in FIG. 2A. The oxide film 16 has a thickness necessary for the GaN insulating film to be formed on the surface of the GaAs substrate 10 by treatments to be described later.

Washing-With-Running Water

Next, as shown in FIG. 1D, washing-with-running water is carried out using deaerated ultrapure water. Here, the oxide film 16 is formed of the Ga₂O₃ having an amorphous structure and As oxides. The Ga₂O₃ having an amorphous structure is difficult to dissolve in water, but the As oxides dissolve in water easily. It is desirable to dissolve and remove the As oxides as much as possible by the washing-with-running water, while leaving the Ga₂O₃ having an amorphous structure in the oxide film.

Accordingly, although the duration of the washing-with-running water may vary depending on dimensions of the GaAs substrate 10, water flow rate, flow speed and the like, the duration is usually selected to be 3 minutes to 5 minutes. Preferably, the washing time is of the order of 1 min. to 10 min. and more preferably of the order of 4 min. to 5 min. A duration of washing-with-running water shorter than three minutes is not preferable because a large amount of the As oxides will remain in the oxide film, and if the time is longer than five minutes, Ga₂O₃ formed in the oxide film 12 may be dissolved and removed excessively. In the present invention, at the time of washing-with-running water, it is desirable that water runs continuously, but the water may instead run intermittently. By the washing-with-running water treatment, an oxide film 18 which is formed mainly of the Ga₂O₃ having an amorphous structure and from which the As oxides have been removed can be formed, as shown in FIG. 2B.

Nitriding Treatment

As shown in FIG. 1E, a nitriding treatment is carried out on the oxide film 18 which is formed mainly of the Ga₂,₃ having an amorphous structure. Any known means in the art can be applied for the nitriding treatment. In the nitriding treatment, the Ga₂O₃ in the oxide film 18 is nitrided to make GaN. However, As oxides act so as to suppress a reaction that produces GaN. However, since the amount of As oxides present in the oxide film 18 is very small, there is very little of components which suppress the reaction that produces GaN. As a result, the Ga₂O₃ becomes GaN efficiently. FIG. 2C shows typical structure of the oxide film after the nitriding treatment. In FIG. 2C, a GaN layer 20 having an amorphous structure has been formed.

A nitrogen plasma method is especially preferable as the nitriding treatment. In the nitrogen plasma method, a process for exposing a substrate with nitrogen plasma may be carried out using a device which generates plasma using an RIE electric source, such as a parallel plate RIE device, a barrel RIE device, a magnetron RIE device, a microwave RIE device, a helicon wave RIE device or the like.

As a gas for producing the nitrogen plasma, besides simple nitrogen, a mixture of nitrogen and argon or a mixture of nitrogen and helium may be used.

In the present invention, the GaAs substrate is not limited to n-GaAs (100). Direction of the surface of the substrate is not restricted, and the GaAs substrate may be an N-type substrate or a P-type substrate.

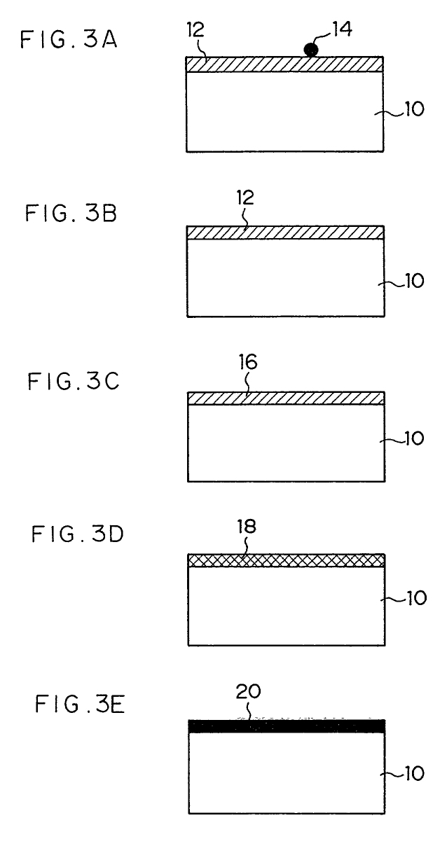

FIGS. 1A to 1E show an example in which aqueous hydrogen peroxide solution is used in the forced oxidation. FIGS. 3A to 3E show an example in which oxygen (O₂) ashing is carried out in the forced oxidation. FIG. 3C shows the state of the oxide film after the oxygen (O₂) ashing. Other processes are substantially the same as those in FIGS. 1A to 1E.

In the above-described embodiments, descriptions have been given for a GaAs substrate. In the present invention, however, an insulating layer formed of a nitride can be formed efficiently by the same treatments as those described above on an AlGaAs substrate or an InGaAs substrate. In the case of an AlGaAs substrate, an insulating film formed of AlGaN is formed efficiently, and in the case of an InGaAs substrate, InGaN is formed efficiently.

### EXAMPLES

Example 1

A GaAs substrate (thickness: 600 μm, size: 3 inches) having a natural oxide film (thickness: 10 Å) on a surface thereof was immersed in acetone for 5 minutes. Then, an ultrasonic wave was applied to the GaAs substrate from the underside thereof such that organic matter on the surface of the GaAs substrate was removed. Then, the GaAs substrate was washed and dried by nitrogen blowing.

Next, the GaAs substrate was immersed in aqueous hydrogen peroxide solution (30%) for 1 minute. Thereafter, the GaAs substrate was washed in running deaerated ultrapure water for 10 minutes. Conditions of the washing-with-running water were 20° C. with bubbling with nitrogen. Then, the GaAs substrate was exposed for 5 minutes to nitrogen plasma which was excited by RF.

The surface of the GaAs substrate was measured by ellipsometry, and an insulating layer which was formed substantially of GaN and had a thickness of 50 Å had been formed thereon.

Example 2

A GaAs substrate (thickness: 600 μm, size: 3 inches) having a natural oxide film (thickness: 10Å) on a surface thereof was immersed in acetone for 5 minutes. Then, an ultrasonic wave was applied to the GaAs substrate from the underside thereof such that organic matter on the surface of the GaAs substrate was removed. Then, the GaAs substrate was washed and dried by nitrogen blowing.

Next, the GaAs substrate was subjected to an oxygen (O₂) ashing treatment. Conditions of the oxygen (O₂) ashing were 300 W, 150 sccm and 2 mTorr. Thereafter, the GaAs substrate was washed with running deaerated ultrapure water for 10 minutes. Conditions of the washing-with-running water were 20° C. with bubbling with nitrogen. Then, the GaAs substrate was exposed for 5 minutes to nitrogen plasma which was excited by RF.

The surface of the GaAs substrate was measured by ellipsometry, and an insulating layer which was formed substantially of GaN and had a thickness of 50 Å had been formed thereon.

Comparative Example 1

A GaAs substrate (thickness: 600 μm, size: 3 inches) having a natural oxide film (thickness: 10 Å) on a surface thereof was immersed in acetone for 5 minutes. Then, an ultrasonic wave was applied to the GaAs substrate from the underside thereof such that organic matter on the surface of the GaAs substrate was removed. Then, the GaAs substrate was washed and dried by nitrogen blowing.

Next, the GaAs substrate was exposed for 5 minutes to nitrogen plasma which was excited by RF. The surface of the GaAs substrate was measured by ellipsometry, and impurities other than GaN, such as GaAsN, AsN, AsOx and the like, were found to be included.

As described above, in accordance with the present invention, a GaAs substrate is actively oxidized to form an oxide film having a desired thickness. Arsenic oxides, which hinder a nitriding treatment, are removed from the oxide film by washing-with-running water such that the oxide film is formed substantially of Ga₂O₃ having an amorphous structure. Thereafter, the oxide film is subjected to the nitriding treatment. Thus, the oxide film can be efficiently made into an insulating film formed of GaN.

What is claimed is:

1. A surface treatment method for a GaAs substrate, the method comprising the steps of:
(i) forcedly oxidizing a surface of the GaAs substrate; and
(ii) thereafter, washing the surface of the GaAs substrate with running water.

2. The surface treatment method for a GaAs substrate according to claim 1, wherein the GaAs substrate is any of a GaAs substrate, an AlGaAs substrate and an InGaAs substrate.

3. The surface treatment method for a GaAs substrate according to claim 1, wherein the step of forcely oxidizing comprises the step of contacting the GaAs substrate with an oxidizing liquid.

4. The surface treatment method for a GaAs substrate according to claim 1, wherein the step of forcedly oxidizing comprises the step of contacting the GaAs substrate with an oxidizing gas.

5. The surface treatment method for a GaAs substrate according to claim 3, wherein the oxidizing liquid is aqueous hydrogen peroxide solution, and the step of contacting the GaAs substrate with an oxidizing liquid comprises the step of immersing the GaAs substrate in the aqueous hydrogen peroxide solution.

6. The surface treatment method for a GaAs substrate according to claim 4, wherein the oxidizing gas is oxygen, and the step of contacting the GaAs substrate with an oxidizing gas comprises the step of treating the GaAs substrate by oxygen ashing.

7. The surface treatment method for a GaAs substrate according to claim 5, wherein the step of immersing the GaAs substrate in the aqueous hydrogen peroxide solution comprises a duration of immersion of from 30 seconds to 3 minutes.

8. A method for forming a GaN insulating layer on a surface of a GaAs substrate, the method comprising the steps of:
(i) forcedly oxidizing the surface of the GaAs substrate;
(ii) washing the surface of the GaAs substrate with running water; and
(iii) exposing the GaAs substrate to nitrogen plasma.

9. The method for forming a GaN insulating layer on a surface of a GaAs substrate according to claim 8, wherein the step of forcedly oxidizing the surface of the GaAs substrate comprises the step of immersing the GaAs substrate in aqueous hydrogen peroxide solution.

10. The method for forming a GaN insulating layer on a surface of a GaAs substrate according to claim 8, wherein the step of forcedly oxidizing the surface of the GaAs substrate comprises the step of treating the GaAs substrate by oxygen ashing.
